(19) United States
(12) Patent Application Publication
(10) Pub. No.: US 2022/0190377 A1
(43) Pub. Date: Jun. 16, 2022

(54) FUEL CELL CARTRIDGE, FUEL CELL MODULE, AND COMBINED POWER GENERATION SYSTEM

(71) Applicant: Mitsubishi Power, Ltd., Kanagawa (JP)

(72) Inventors: Ryutaro MORI, Tokyo (JP); Norihisa MATAKE, Tokyo (JP); Masahiro MIHARA, Yokohama-shi, Kanagawa (JP); Daigo KOBAYASHI, Yokohama-shi, Kanagawa (JP); Nagao HISATOME, Yokohama-shi, Kanagawa (JP)

(21) Appl. No.: 17/432,229

(22) PCT Filed: Feb. 17, 2020
(86) PCT No.: PCT/JP2020/005963

§ 371 Date: Aug. 19, 2021

(30) Foreign Application Priority Data
Feb. 27, 2019 (JP) 2019-033433

(51) Int. Cl. H01M 8/249; H01M 8/2457; H01M 8/04111; H01M 8/2465

(52) U.S. Cl. CPC H01M 8/249; H01M 8/2465; H01M 8/04111; H01M 8/2457

(57) ABSTRACT

This fuel cell cartridge includes a plurality of cell stacks including a plurality of cells for forming a solid oxide fuel cell. A cell stack group including the plurality of cell stacks includes an inner cell stack group arranged in an inner region of a cell arrangement region and an outer cell stack group arranged in an outer region. The inner cell stack group and the outer cell stack group are connected in series and a current density of the outer cell stack group is configured to be higher than a current density of the inner cell stack group.

### TECHNICAL FIELD

The present disclosure relates to fuel cell cartridges, fuel cell modules, and combined cycle power generation systems for solid oxide fuel cells.

### BACKGROUND

Fuel cells which are power generation devices using a power generation method by an electrochemical reaction, and have characteristics such as excellent power generation efficiency and environmental friendliness are known. Among the fuel cells, solid oxide fuel cells (SOFC) generate electric power using hydrogen and carbon monoxide produced by reforming fuels such as city gas, natural gas, and coal gas, using ceramics such as zirconia ceramics as an electrolyte. The solid oxide fuel cell has a high operating temperature of about 700° C. to 1100° C. in order to increase the ionic conductivity, and is known as a versatile and highly efficient high-temperature fuel cell. The solid oxide fuel cell generates electric power by reaction of an oxidant gas with a fuel gas supplied to the inside and the outside of a tubular cell stack (cell tube) having a cathode and an anode, for example.

SOFCs can generate electric power more efficiently by increasing the combined operating pressure with rotating equipment such as gas turbines, micro gas turbines and turbochargers. In such a pressurizing system, the compressed air discharged from a compressor is supplied to the cathode of the SOFC as an oxidized gas. The high-temperature exhaust fuel gas discharged from the SOFC is supplied to a combustor at the inlet of the rotating equipment and is burned. The rotating equipment is rotated with the high-temperature combustion gas generated by the combustor. In this way, power can be recovered.

Patent Literature 1 discloses a fuel cell device that facilitates wiring work by electrically connecting a plurality of cell stacks constituting a fuel cell with a conductive current collecting member. In such a plurality of cell stacks, a temperature distribution that is not negligible occurs during operation, and the internal resistance of each cell stack depends on the temperature. That is, the higher the temperature of the cell stack, the smaller the internal resistance and the easier it is for the current to flow. Therefore, if the current is distributed to the cell stacks so that the voltages of the cell stacks connected in parallel are equal, an imbalance occurs in the current flowing through the cell stacks. Patent Literature 1 proposes a configuration in which a plurality of cell stacks is classified into a high-temperature region and a low-temperature region in order to suppress such a current imbalance, and cell stacks which are electrically connected by divided current collecting member are connected to each other.

### CITATION LIST

### Patent Literature

Patent Literature 1: JP2016-81647A

### SUMMARY

### Technical Problem

In Patent Literature 1, a plurality of cell stacks is classified so as to correspond to a high-temperature region and a low-temperature region determined on the basis of a temperature distribution, and the cell stacks are electrically connected by divided current collecting members. However, depending on the number of cell stacks connected by each current collecting member, the number of cell stacks in the high-temperature region may be equal to or smaller than the number of cell stacks in the low-temperature region, and the current density in the high-temperature region may be higher than the current density in the low-temperature region. This means that the amount of heat generated in the high-temperature region is larger than the amount of heat generated in the low-temperature region, which acts in the direction of promoting the deviation of the temperature distribution. Therefore, in Patent Literature 1, there is a possibility that the temperature distribution between a plurality of cell stacks, which causes a current imbalance, is not sufficiently equalized.

At least one embodiment of the present invention has been made in view of the above circumstances, and an object thereof is to provide a fuel cell cartridge, a fuel cell module, and a combined cycle power generation system capable of equalizing the temperature distribution between a plurality of cell stacks.

### Solution to Problem

(1) In order to solve the above problems, a fuel cell cartridge according to at least one embodiment of the present invention is fuel cell cartridge including a plurality of cell stacks including a plurality of cells forming a solid oxide fuel cell, wherein the cell stack group including the plurality of cell stacks includes: an inner cell stack group arranged in an inner region of a cell arrangement region in which the plurality of cell stacks is arranged; and an outer cell stack group arranged in an outer region located outside the inner region of the cell arrangement region, the inner cell stack group and the outer cell stack group are connected in series with respect to an external load, and a current density of the outer cell stack group is configured to be higher than a current density of the inner cell stack group.

According to the configuration of (1), the cell stack group including a plurality of cell stacks included in the fuel cell cartridge includes an inner cell stack group and an outer cell stack group arranged outside the inner cell stack. The inner cell stack group and the outer cell stack group are connected in series with respect to the external load, and the current density of the outer cell stack group is configured to be higher than the current density of the inner cell stack group during energization. Therefore, the amount of heat generated in the outer cell stack group is relatively larger than that in the inner cell stack group as compared with the case where the current densities of the inner cell stack group and the outer cell stack group are equal to each other. As a result, it is possible to equalize the temperature distribution between the outer cell stack group in which the heat dissipation amount is larger than the inner cell stack group, and the inner cell stack group in which the heat dissipation amount is smaller than the outer cell stack group.

(2) In some embodiments, in the configuration of (1), the plurality of cell stacks have the same conductive area, and the outer cell stack group includes a smaller number of cell stacks than the inner cell stack group.

According to the configuration of (2), the cell stacks constituting the fuel cell cartridge have the same conductive area. By reducing the number of cell stacks included in the outer cell stack group to be smaller than the number of cell stacks included in the inner cell stack group, when the inner cell stack group and the outer cell stack group are connected in series to the external load during energization, the current density of the outer cell stack group can be configured to be higher than the current density of the inner cell stack group.

(3) In some embodiments, in the configuration of (1) or (2), the cell stacks constituting the inner cell stack group and the cell stacks constituting the outer cell stack group are electrically connected by mutually independent current collecting members.

According to the configuration of (3), the cell stacks constituting the inner cell stack group and the outer cell stack group are electrically connected by independent current collecting members. As a result, the above configuration can be realized with an efficient layout without significantly changing the configuration of the conventional fuel cell cartridge in which a large number of cell stacks are arranged.

(4) In some embodiments, in any one of (1) to (3), the outer cell stack group surrounds an entire circumference of the inner cell stack group.

According to the configuration of (4), since the entire circumference of the inner cell stack group is surrounded by the outer cell stack group, the amount of heat dissipation tends to be smaller and the temperature tends to be higher than that of the outer cell stack group. By setting the current density of the outer cell stack group to be higher than that of the inner cell stack group, the temperature distribution can be equalized.

(5) In some embodiments, in any one of (1) to (3), the outer cell stack group is arranged on both sides of the inner cell stack group.

According to the configuration of (5), by adopting a configuration in which the outer cell stack group is arranged on both sides of the inner cell stack group, the temperature distribution can be equalized even when a plurality of the fuel cell cartridges are arranged and expanded.

(6) In some embodiments, in any one of (1) to (5), the inner cell stack group includes a first inner cell stack group and a second inner cell stack group that adjacent to each other, and the first inner cell stack group and the second inner cell stack group are connected in series.

According to the configuration of (6), the inner cell stack group is further subdivided into a first inner cell stack group and a second inner cell stack group adjacent to each other. By connecting the first inner cell stack group and the inner cell stack group in series with each other, the temperature distribution in the inner cell stack group can be further equalized.

(7) In some embodiments, in any one of (1) to (6), the cell stack has a cylindrical horizontal stripe shape in which a plurality of fuel cells are electrically connected in series.

According to the configuration of (7), the above configuration is suitably applicable to a fuel cell cartridge including a cell stack having a cylindrical horizontal stripe shape.

(8) In some embodiments, in any one of (1) to (6), the cell stack has a flat cylindrical horizontal stripe shape.

According to the configuration of (8), the above configuration is suitably applicable to a fuel cell cartridge including a cell stack having a flat cylindrical horizontal stripe shape.

(9) A fuel cell module according to at least one embodiment of the present invention includes the fuel cell cartridge according to any one of (1) to (8).

According to the configuration (9), a fuel cell module capable of generating electric power more efficiently can be realized by equalizing the temperature distribution in the plurality of cell stacks constituting the fuel cell cartridge.

(10) In order to solve the above problems, a combined cycle power generation system according to at least one embodiment of the present invention includes the fuel cell module according to (9) and a gas turbine or turbocharger that generates rotational power using an exhaust fuel gas and an exhaust oxidized gas exhausted from the fuel cell, in which the fuel cell module is supplied with the oxidized gas compressed using the rotational power, and the plurality of cell stacks generates power using the fuel gas and the oxidized gas.

According to the configuration (10), a combined cycle power generation system capable of generating electric power more efficiently can be realized.

### Advantageous Effects

According to at least one embodiment of the present invention, it is possible to provide a fuel cell cartridge, a fuel cell module, and a combined cycle power generation system capable of equalizing the temperature distribution among a plurality of cell stacks.

### BRIEF DESCRIPTION OF DRAWING

FIG. 1 is a perspective view illustrating an overall configuration of a fuel cell module according to at least one embodiment of the present invention.

FIG. 2 is a cross-sectional view illustrating an internal configuration of the fuel cell cartridge of FIG. 1.

FIG. 3 is a cross-sectional view illustrating the cell stack of FIG. 2.

FIG. 4 is a plan view of the fuel cell cartridge as viewed from above in the vertical direction.

FIG. 5 is a cross-sectional perspective view taken along the line L-L of the fuel cell cartridge illustrated in FIG. 4.

FIG. 6 is a diagram illustrating a temperature distribution along the line L-L in FIG. 4.

FIG. 7 is a first modification of FIG. 4.

FIG. 8 is a cross-sectional perspective view taken along the line N-N of the fuel cell cartridge illustrated in FIG. 7.

FIG. 9 is an expanded example of a fuel cell cartridge of the first modification.

FIG. 10 is a second modification of FIG. 4.

FIG. 11 is a cross-sectional perspective view taken along the line O-O of the fuel cell cartridge illustrated in FIG. 10.

FIG. 12 is a schematic view illustrating a fuel cell cartridge having a flat cylindrical cell stack.

### DETAILED DESCRIPTION

Embodiments of the present invention will now be described in detail with reference to the accompanying drawings. It is intended, however, that unless particularly specified, dimensions, materials, shapes, relative positions and the like of components described in the embodiments shall be interpreted as illustrative only and not limitative of the scope of the present invention.

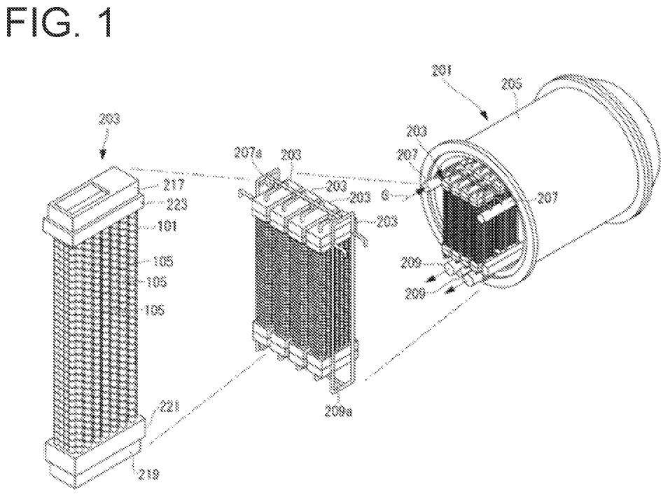

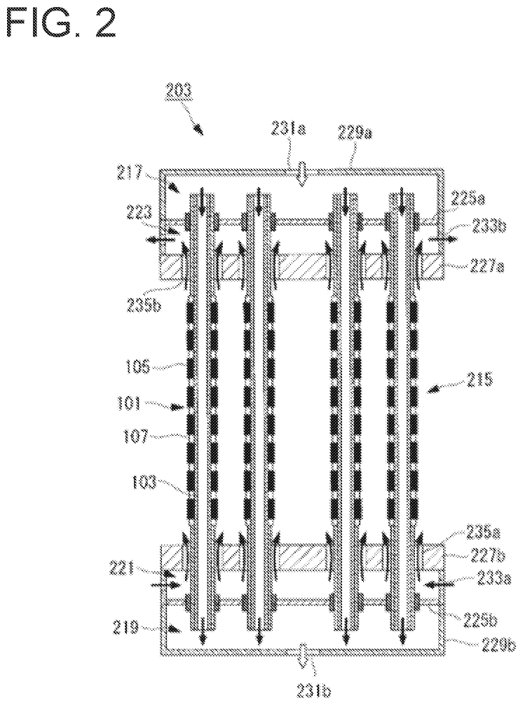

FIG. 1 is a perspective view illustrating an overall configuration of a fuel cell module 201 according to at least one embodiment of the present invention, and FIG. 2 is a cross-sectional view illustrating an internal configuration of a fuel cell cartridge 203 of FIG. 1. The fuel cell module 201 includes a plurality of fuel cells cartridges 203 and a pressure vessel 205 for accommodating the plurality of fuel cells cartridges 203. The fuel cell module 201 has a fuel gas supply pipe 207 and a plurality of fuel gas supply branch pipes 207a. The fuel cell module 201 has a fuel gas exhaust pipe 209 and a plurality of fuel gas exhaust branch pipes 209a. The fuel cell module 201 has an oxidized gas supply pipe (not illustrated) and an oxidized gas supply branch pipe (not illustrated). The fuel cell module 201 has an oxidized gas exhaust pipe (not illustrated) and a plurality of oxidized gas exhaust branch pipes (not illustrated).

The fuel gas supply pipe 207 is provided inside the pressure vessel 205 and is connected to the plurality of fuel gas supply branch pipes 207a as well as a fuel supply system (not illustrated) that supplies a predetermined gas composition and a predetermined flow rate of fuel gas G in accordance with the amount of power generated by the fuel cell module 201. The fuel gas supply pipe 207 branches and guides a predetermined flow rate of fuel gas supplied from the fuel supply system (not illustrated) to the plurality of fuel gas supply branch pipes 207a.

The fuel gas supply branch pipe 207a is connected to the plurality of fuel cells cartridges 203 as well as the fuel gas supply pipe 207. The fuel gas supply branch pipe 207a guides the fuel gas supplied from the fuel gas supply pipe 207 to the plurality of fuel cells cartridges 203 at a substantially equal flow rate, and substantially equalizes the power generation performance of the plurality of fuel cells cartridges 203.

The fuel gas exhaust branch pipe 209a is connected to the fuel gas exhaust pipe 209 as well as the plurality of fuel cells cartridges 203. The fuel gas exhaust branch pipe 209a guides the exhaust fuel gas discharged from the fuel cell cartridge 203 to the fuel gas exhaust pipe 209. The fuel gas exhaust pipe 209 is connected to the plurality of fuel gas exhaust branch pipes 209a, and a portion thereof is arranged inside the pressure vessel 205. The fuel gas exhaust pipe 209 guides the exhaust fuel gas led out from the fuel gas exhaust branch pipe 209a at a substantially equal flow rate to a fuel gas discharge system (not illustrated) outside the pressure vessel 205.

The pressure vessel 205 is operated at an internal pressure of 0.1 MPa to about 1 MPa and an internal temperature is operated at atmospheric temperature to about 550° C., and a material having pressure resistance and corrosion resistance to oxidizing agents such as oxygen included in the oxidized gas is used. For example, a stainless steel material such as SUS304 is suitable.

As illustrated in FIG. 2, the fuel cell cartridge 203 includes a plurality of cell stacks 101, a power generation room 215, a fuel gas supply room 217, a fuel gas discharge room 219, an oxidized gas supply room 221, and an oxidized gas discharge room 223. The fuel cell cartridge 203 has an upper tube plate 225a, a lower tube plate 225b, an upper heat insulation 227a, and a lower heat insulation 227b.

In the present embodiment, the fuel cell cartridge 203 has a structure in which the fuel gas supply room 217, the fuel gas discharge room 219, the oxidized gas supply room 221, and the oxidized gas discharge room 223 are arranged as illustrated in FIG. 2 such that the fuel gas and the oxidized gas flow in opposite directions inside and outside the cell stack 101, but other structures may be used. For example, the gases may flow in parallel inside and outside the cell stack 101 may flow in parallel, or the oxidized gas may flow in a direction orthogonal to the longitudinal direction of the cell stack 101.

The power generation room 215 is a region formed between the upper heat insulation 227a and the lower heat insulation 227b. The power generation room 215 is a region in which the fuel cells 105 of the cell stack 101 are arranged and the fuel gas and the oxidized gas react electrochemically with each other to generate electric power. The temperature in the vicinity of the central portion of the power generation room 215 in the longitudinal direction of the cell stack 101 is in a high temperature atmosphere of about 700° C. to 1100° C. during a normal operation of the fuel cell module 201.

The fuel gas supply room 217 is a region surrounded by an upper casing 229a and the upper tube plate 225a of the fuel cell cartridge 203. The fuel gas supply room 217 is communicated with the fuel gas supply branch pipe 207a (not illustrated) by a fuel gas supply hole 231a provided in the upper casing 229a. One end of the cell stack 101 is arranged in the fuel gas supply room 217 so that the inside of a substrate tube 103 of the cell stack 101 is open to the fuel gas supply room 217. The fuel gas supply room 217 guides the fuel gas supplied from the fuel gas supply branch pipe 207a (not illustrated) through the fuel gas supply hole 231a to the inside of the substrate tubes 103 of the plurality of cell stacks 101 at a substantially uniform flow rate to substantially equalize the power generation performance of the plurality of cell stacks 101.

The fuel gas discharge room 219 is a region surrounded by a lower casing 229b and the lower tube plate 225b of the fuel cell cartridge 203. The fuel gas discharge room 219 is communicated with the fuel gas exhaust branch pipe 209a (not illustrated) by a fuel gas exhaust hole 231b provided in the lower casing 229b. The other end of the cell stack 101 is arranged in the fuel gas discharge room 219 so that the inside of the substrate tube 103 of the cell stack 101 is open to the fuel gas discharge room 219. The fuel gas discharge room 219 aggregates the exhaust fuel gas that has passed through the inside of the substrate tubes 103 of the plurality of cell stacks 101 and has been supplied to the fuel gas discharge room 219, and guides the aggregated exhaust fuel gas to the fuel gas supply branch pipe 209a (not illustrated) through the fuel gas exhaust hole 231b.

A predetermined gas composition and a predetermined flow rate of oxidized gas is branched into oxidized gas supply branch pipes according to the amount of power generated by the fuel cell module 201 and is supplied to the plurality of fuel cells cartridges 203. The oxidized gas supply room 221 is a region surrounded by the lower casing 229b, the lower tube plate 225b, and the lower heat insulation 227b of the fuel cell cartridge 203. The oxidized gas supply room 221 is communicated with the oxidized gas supply branch pipe (not illustrated) by an oxidized gas supply hole 233a provided in the lower casing 229b. The oxidized gas supply room 221 guides a predetermined flow rate of oxidized gas supplied from the oxidized gas supply branch pipe (not illustrated) through the oxidized gas supply hole 233a to the power generation room 215 through an oxidized gas supply gap 235a described later.

The oxidized gas discharge room 223 is a region surrounded by the upper casing 229a, the upper tube plate 225a, and the upper heat insulation 227a of the fuel cell cartridge 203. The oxidized gas discharge room 223 is communicated with the oxidized gas exhaust branch pipe (not illustrated) by an oxidized gas exhaust hole 233b provided in the upper casing 229a. The oxidized gas discharge room 223 guides the exhaust oxidized gas supplied from the power generation room 215 to the oxidized gas discharge room 223 through the oxidized gas exhaust gap 235b, which will be described later, to an oxidized gas exhaust branch pipe (not illustrated) through the oxidized gas exhaust hole 233b.

The upper tube plate 225a is fixed to a side plate of the upper casing 229a between a top plate of the upper casing 229a and the upper insulation 227a so that the upper tube plate 225a, the top plate of the upper casing 229a, and the upper insulation 227a are substantially parallel to each other. The upper tube plate 225a has a plurality of holes corresponding to the number of cell stacks 101 provided in the fuel cell cartridge 203, and the cell stacks 101 are inserted into the holes, respectively. The upper tube plate 225a airtightly supports one set of ends of the plurality of cell stacks 101 with the aid of either one or both of a sealing member and an adhesive member, and isolates the fuel gas supply room 217 and the oxidized gas discharge room 223 from each other.

The lower tube plate 225b is fixed to a side plate of the lower casing 229b between a bottom plate of the lower casing 229b and the lower insulation 227b so that the lower tube plate 225b, the bottom plate of the lower casing 229b, and the lower heat insulation 227b are substantially parallel to each other. The lower tube plate 225b has a plurality of holes corresponding to the number of cell stacks 101 provided in the fuel cell cartridge 203, and the cell stacks 101 are inserted into the holes, respectively. The lower tube plate 225b airtightly supports the other set of ends of the plurality of cell stacks 101 with the aid of either or both of a sealing member and an adhesive member, and isolates the fuel gas discharge room 219 and the oxidized gas supply room 221 from each other.

The upper heat insulation 227a is arranged at the lower end of the upper casing 229a so that the upper heat insulation 227a, the top plate of the upper casing 229a, and the upper tube plate 225a are substantially parallel to each other, and is fixed to the side plate of the upper casing 229a. The upper heat insulation 227a is provided with a plurality of holes corresponding to the number of cell stacks 101 provided in the fuel cell cartridge 203. The diameter of this hole is set to be larger than the outer diameter of the cell stack 101. The upper heat insulation 227a has an oxidized gas exhaust gap 235b formed between the inner surface of the hole and the outer surface of the cell stack 101 inserted through the upper heat insulation 227a.

The upper heat insulation 227a separates the power generation room 215 and the oxidized gas discharge room 223, and suppresses an increase in the temperature of the atmosphere around the upper tube plate 225a to thereby suppress a decrease in strength and an increase in corrosion due to an oxidizing agent included in the oxidized gas. The upper tube plate 225a and the like are made of a metal material having high temperature durability such as Inconel, and prevents the upper tube plate 225a and the like from being exposed to the high temperature in the power generation room 215 and an increase in the temperature difference from the upper casing 229a to thereby prevent thermal deformation. The upper heat insulation 227a guides the exhaust oxidized gas that has passed through the power generation room 215 and has been exposed to the high temperature to the oxidized gas discharge room 223 through the oxidized gas exhaust gap 235b.

According to the present embodiment, due to the structure of the fuel cell cartridge 203 described above, the fuel gas and the oxidized gas flow in opposite directions inside and outside the cell stack 101. As a result, the exhaust oxidized gas exchanges heat with the fuel gas supplied to the power generation room 215 through the inside of the substrate tube 103, and is cooled to a temperature at which the upper tube plate 224a or the like made of a metal material does not deform due to buckling or the like and the cooled exhaust oxidized gas is supplied to the oxidized gas discharge room 223. The fuel gas is heated by heat exchange with the exhaust oxidized gas discharged from the power generation room 215 and is supplied to the power generation room 215. As a result, the fuel gas preheated to a temperature suitable for power generation without using a heater or the like can be supplied to the power generation room 215.

The lower heat insulation 227b is arranged at the upper end of the lower casing 229b so that the lower heat insulation 227b, the bottom plate of the lower casing 229b, and the lower tube plate 225b are substantially parallel to each other, and is fixed to the side plate of the upper casing 229a. The lower heat insulation 227b is provided with a plurality of holes corresponding to the number of cell stacks 101 provided in the fuel cell cartridge 203. The diameter of this hole is set to be larger than the outer diameter of the cell stack 101. The lower heat insulation 227b has an oxidized gas supply gap 235a formed between the inner surface of the hole and the outer surface of the cell stack 101 inserted through the lower heat insulation 227b.

The lower heat insulation 227b separates the power generation room 215 and the oxidized gas supply room 221, and the suppresses an increase in the temperature of the atmosphere around the lower tube plate 225b to thereby suppress a decrease in strength and an increase in corrosion due to an oxidizing agent included in the oxidized gas. The lower tube plate 225b and the like are made of a metal material having high temperature durability such as Inconel, and prevent the lower tube plate 225b and the like from being exposed to the high temperature and an increase in the temperature difference from the lower casing 229b to thereby prevent deformation. The lower heat insulation 227b guides the oxidized gas supplied to the oxidized gas supply room 233 to the power generation room 215 through the oxidized gas supply gap 235a.

According to the present embodiment, due to the structure of the fuel cell cartridge 203 described above, the fuel gas and the oxidized gas flow in opposite direction inside and outside the cell stack 101. As a result, the exhaust fuel gas that has passed through the power generation room 215 through the inside of the substrate tube 103 exchanges heat with the oxidized gas supplied to the power generation room 215, and is cooled to a temperature at which the lower tube plate 225b or the like made of a metal material that does not deform due to buckling or the like and the cooled exhaust fuel gas is discharged to the fuel gas discharge room 219. The oxidized gas is heated by heat exchange with the exhaust fuel gas and is supplied to the power generation room 215. As a result, the oxidized gas heated to the temperature required for power generation without using a heater or the like can be supplied to the power generation room 215.

The DC power generated in the power generation room 215 is led out to the vicinity of the end of the cell stack 101 by a lead film 115 made of Ni/YSZ or the like provided in the plurality of fuel cells 105, and is then collected by a current collecting mechanism of the fuel cell cartridge 203 and is taken out to the outside of each fuel cell cartridge 203. The pieces of electric power led out to the outside of the fuel cell cartridges 203 by the current collecting mechanism, that is, the pieces of electric power generated by the fuel cell cartridges 203, are connected to a predetermined series number and a predetermined parallel number and are led out to the outside of the fuel cell module 201. After that, the electric power is converted to predetermined AC power by an inverter or the like and supplied to a power load. The details of the current collecting mechanism for collecting DC power will be described later.

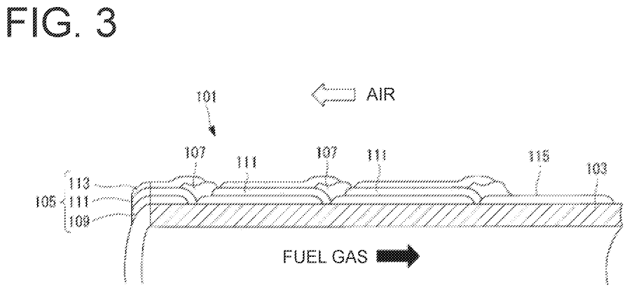

Next, a cylindrical cell stack of the present embodiment will be described with reference to FIG. 3. FIG. 3 is a cross-sectional view illustrating the cell stack 101 of FIG. 2.

The cell stack 101 has the cylindrical substrate tube 103, the plurality of fuel cells 105 formed on the outer circumferential surface of the substrate tube 103, and an interconnector 107 formed between adjacent fuel cells 105. The fuel cell 105 is formed by stacking an anode 109, an electrolyte 111, and a cathode 113. The cell stack 101 has the lead film 115 electrically connected via the interconnector 107 to the cathode 113 of the single fuel cell 105 closest to the end in the axial direction of the substrate tube 103 among the plurality of single fuel cells 105 formed on the outer circumferential surface of the substrate tube 103.

The substrate tube 103 is made of a porous material and contains, for example, CaO-stabilized ZrO₂ (CSZ), Y₂O₃-stabilized ZrO₂ (YSZ), or MgAl₂O₄. The substrate tube 103 supports the fuel cell 105, the interconnector 107, and the lead film 115, and diffuses the fuel gas supplied to the inner circumferential surface of the substrate tube 103 to the anode 109 formed on the outer circumferential surface of the substrate tube 103 through fine pores of the substrate tube 103.

The anode 109 is formed of an oxide of a composite material of Ni and a zirconia-based electrolyte material, and for example, Ni/YSZ is used. In this case, the anode 109, specifically, Ni, which is a component of the anode 109, has a catalytic action on the fuel gas. This catalytic action is to cause a reaction of the fuel gas supplied through the substrate tube 103 (for example, a mixed gas of methane (CH₄) and water vapor) to reform it into hydrogen (H₂) and carbon monoxide (CO). The anode 109 causes an electrochemical reaction of hydrogen (H₂) and carbon monoxide (CO) obtained by reforming and oxygen ions (O²⁻) supplied via the electrolyte 111 near the interface with the electrolyte 111 to produce water (H₂O) and carbon dioxide (CO₂). At this time, the fuel cell 105 generates electric power by the electrons emitted from the oxygen ions.

YSZ, which has airtightness that makes it difficult for gas to pass through and high oxygen ion conductivity at high temperature, is mainly used as the electrolyte 111. The electrolyte 111 allows the oxygen ions (O²⁻) generated at the cathode to move toward the anode.

The cathode 113 is formed of, for example, LaSrMnO₃-based oxide or LaCoO₃-based oxide. The cathode 113 dissociates oxygen in an oxidized gas such as the supplied air in the vicinity of the interface with the electrolyte 111 to generate oxygen ions (O²⁻).

The interconnector 107 is formed of a conductive perovskite-type oxide represented by M₁₋ₓLₓTiO₃ (M is an alkaline earth metal element and L is a lanthanoid element) such as SrTiO₃ system, and is a dense film in which the fuel gas and the oxidized gas are not mixed. The interconnector 107 has stable electrical conductivity in both an oxidizing atmosphere and a reducing atmosphere. The interconnector 107 electrically connects the cathode 113 of one fuel cell 105 and the anode 109 of the other fuel cell 105 in adjacent fuel cells 105 to connect the adjacent fuel cells 105 in series.

Since the lead film 115 needs to have electron conductivity and a thermal expansion coefficient close to that of other materials constituting the cell stack 101, the lead film 115 is formed of a composite material of Ni such as Ni/YSZ and a zirconia-based electrolyte material. The lead film 115 leads the DC power generated by the plurality of fuel cells 105 connected in series by the interconnector out to the vicinity of the end of the cell stacks 101.

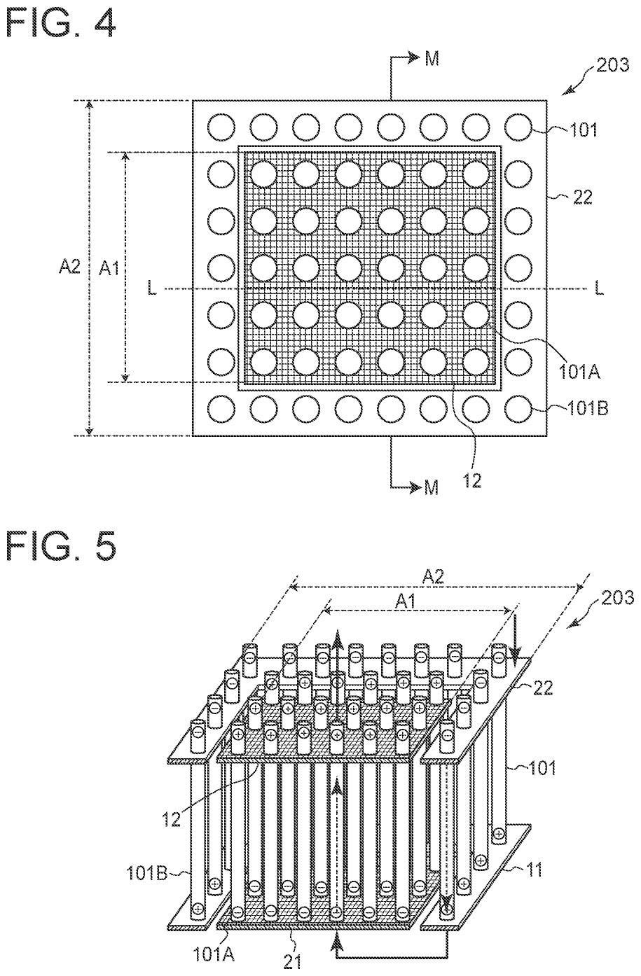

Next, the current collecting mechanism of the fuel cell cartridge 203 will be described. FIG. 4 is a plan view of the fuel cell cartridge 203 as viewed from above in the vertical direction (in FIG. 4, the upper casing 229a is omitted). FIG. 5 is a cross-sectional perspective view taken along the line L-L of the fuel cell cartridge 203 illustrated in FIG. 4. FIG. 2 described above corresponds to the cross-sectional view taken along the line M-M of FIG. 4.

The fuel cell cartridge 203 includes a plurality of cylindrical cell stacks 101 constituting the fuel cell (in the present embodiment, the fuel cell cartridge 203 is provided with a total of 56 cell stacks 101). Each cell stack 101 has the cathode 113 (positive electrode) and the anode 109 (negative electrode) as described with reference to FIG. 3. As described above with reference to FIG. 2, the cell stacks 101 are supported by the upper casing 229a (housing) and the lower casing 229b (housing) so as to be arranged so that the central axis of the cell stacks 101 extend in the vertical direction and are adjacent to each other in the horizontal plane orthogonal to the central axis.

As illustrated in FIGS. 4 and 5, the cell stack groups including the plurality of cell stacks 101 are classified to include an inner cell stack group 101A arranged in an inner region A1 of a cell arrangement region A in which the plurality of cell stacks 101 are arranged and an outer cell stack group 101B arranged in an outer region A2 located outside the inner region A1 of the cell arrangement region A.

The fuel cell cartridge 203 includes a current collector plate 11 (first positive electrode current collector), a current collector plate 12 (second positive electrode current collector), a current collector plate 21 (first negative electrode current collector), and a current collector plate 22 (second negative electrode current collector). The current collector plate 11 (first positive electrode current collector) is a conductive plate member that electrically connects the positive electrodes of the outer cell stack groups 101B, and is arranged in the outer region A2. The current collector plate 12 (second positive electrode current collector) is a conductive plate member that electrically connects the positive electrodes of the inner cell stack groups 101A, and is arranged in the inner region A1. The current collector plate 21 (first negative electrode current collector) is a conductive plate member that electrically connects the negative electrodes of the inner cell stack groups 101A, and is arranged in the inner region A1. The current collector plate 22 (second negative electrode current collector) is a conductive plate member that electrically connects the negative electrodes of the outer cell stack groups 101B, and is arranged in the outer region A2.

As illustrated in FIG. 5, a path in which current is circulated in the fuel cell cartridge 203 is formed by electrically separating the current collector plate 21 and the current collector plate 22 and electrically connecting the current collector plate 21 and the current collector plate 11. This path is a path in which the inner cell stack group 101A of the inner region A1 and the outer cell stack group 101B of the outer region A2 are connected in series with respect to an external load (not illustrated).

The arrows illustrated in the path indicate the circulation direction of the current flowing through the path. In the following drawings, the arrows illustrated in the path indicate the circulation direction of the current flowing through the path.

Here, the cell stacks 101 included in the fuel cell cartridge 203 have the same conductive area, and the outer cell stack group 101B includes a smaller number of cell stacks 101 than the inner cell stack group 101A. Therefore, when the inner cell stack group 101A and the outer cell stack group 101B connected in series to an external load are energized, the current density of the outer cell stack group 101B having a small total conductive area is configured to be higher than the current density of the inner cell stack group 101A having a large total conductive area.

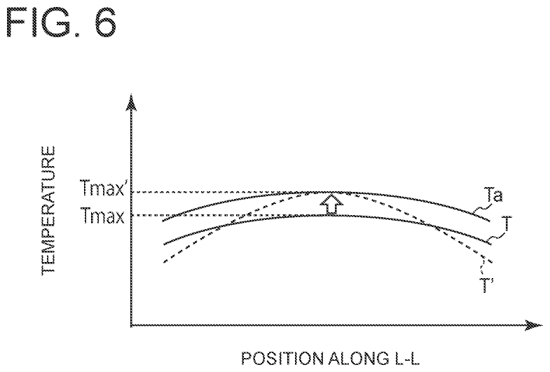

FIG. 6 illustrates the temperature distribution T along the line L-L in FIG. 4. In FIG. 6, as a comparative example, the temperature distribution T′ corresponding to the case where the inner cell stack group 101A and the outer cell stack group 101B have the same number and the current densities of both are equal is illustrated by a broken line. In this comparative example, the temperature distribution T′ is illustrated in which the temperature is low in the outer cell stack group 101B having a large amount of heat dissipation to the outside and the temperature is low in the inner cell stack group 101A having a small amount of heat dissipation to the outside. The temperature distribution T′ has a maximum temperature Tmax′.

On the other hand, in the present embodiment, as described above, since the current density of the outer cell stack group 101B is configured to be higher than the current density of the inner cell stack group 101A, the amount of heat generated in the outer cell stack group 101B is increased relative to the inner cell stack group 101A. As a result, an equalized temperature distribution T as compared with the comparative example is obtained.

In the present embodiment, as illustrated in FIG. 4, since the outer cell stack group 101B is configured to surround the entire circumference of the inner cell stack group 101A, the inner cell stack group 101A is likely to dissipate a larger amount of heat and have a higher temperature than the outer cell stack group 101B. However, by setting the current density of the outer cell stack group 101B to be higher than that of the inner cell stack group 101A, the temperature distribution can be effectively equalized.

This temperature distribution T is equalized while suppressing the maximum temperature Tmax as compared with the maximum temperature Tmax′ of the comparative example. Therefore, as illustrated as the temperature distribution Ta in FIG. 6, the output of the fuel cell cartridge 203 can be improved and the fuel cell cartridge 203 having higher efficiency can be realized while maintaining the maximum temperature equivalent to the maximum temperature Tmax′ of the comparative example to the upper limit.

Such a configuration can be constructed by electrically connecting the inner cell stack group 101A and the outer cell stack group 101B by independent current collecting members like the above-mentioned current collector plates (the current collector plate 11 (first positive electrode current collector), the current collector plate 12 (second positive electrode current collector), the current collector plate 21 (first negative electrode current collector), and the current collector plate 22 (second negative electrode current collector)). As a result, the above configuration can be realized with an efficient layout without significantly changing the configuration of the conventional fuel cell cartridge in which a large number of cell stacks are arranged.

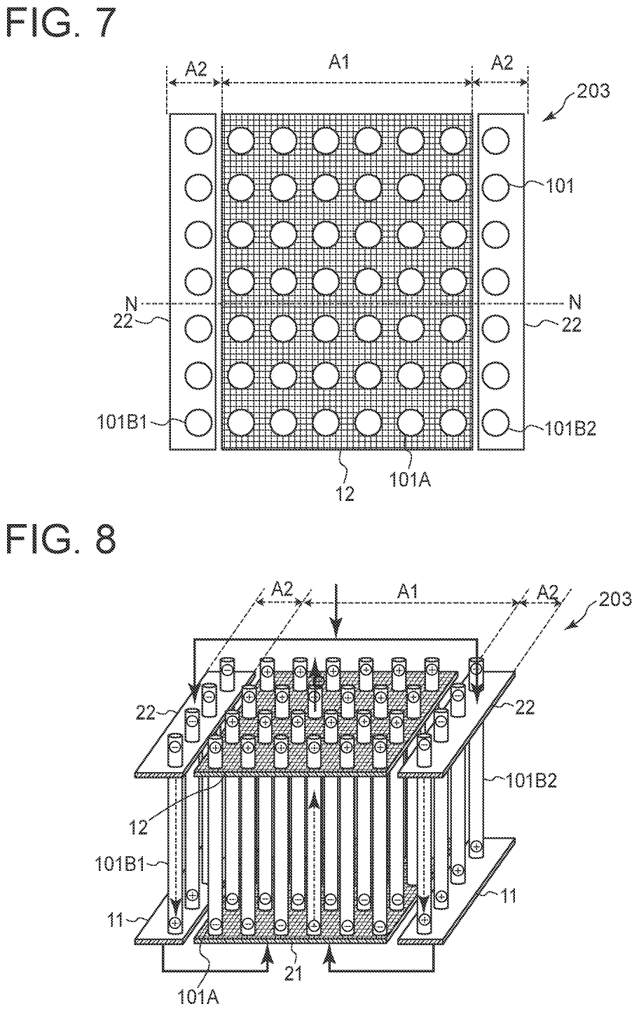

FIG. 7 is a first modification of FIG. 4, and FIG. 8 is a cross-sectional perspective view taken along the line N-N of the fuel cell cartridge 203 illustrated in FIG. 7. In this first modification, two outer regions A2 are defined on both sides of the inner region A1, so that the outer cell stack groups 101B1 and 101B2 are arranged on both sides of the inner cell stack group 101A.

A path in which current is circulated in the fuel cell cartridge 203 is a parallel combination of two paths, one path illustrated on the left side of FIG. 8 in which the outer cell stack group 101B1 and the inner cell stack group 101A are connected in series to an external load (not illustrated) and the other path illustrated on the right side of FIG. 8 in which the outer cell stack group 101B2 and the inner cell stack group 101A are connected in series to an external load (not illustrated).

Even when the outer cell stack group 101B is divided and provided on both sides of the inner cell stack group 101A in this way, the temperature distribution can be equalized effectively by setting the current density of the outer cell stack group 101B to be higher than that of the inner cell stack group 101A.

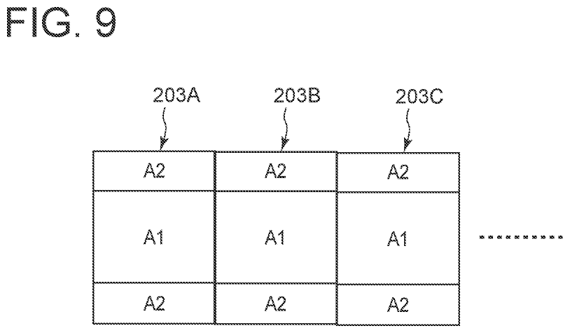

FIG. 9 is an expanded example of the fuel cell cartridge 203 of the first modification. In FIG. 9, fuel cell cartridges 203A, 203B, 203C, and so on according to the first modification are arranged along a predetermined direction, and the inner regions A1 and the outer regions A2 of adjacent fuel cell cartridges 203 are arranged continuously. Even when the plurality of fuel cells cartridges 203 are expanded by arranging them to be adjacent to each other in this way, the temperature distribution across the plurality of fuel cell cartridges 203 can be equalized effectively by setting the current density of the outer cell stack group 101B having a relatively large heat dissipation amount to be higher than that of the inner cell stack group 101A having a relatively small heat dissipation amount.

When the plurality of fuel cells cartridges 203 are expanded and arranged, since the contact surface between adjacent fuel cell cartridges 203 is close to a heat insulating state and a temperature gradient is unlikely to occur, there is little need for equalizing the temperature distribution. In such a case, as illustrated in FIG. 9, by configuring the current collector plates in column units, it is possible to equalize the temperature distribution in the direction perpendicular to the arrangement direction with an efficient layout.

The outer cell stack groups 101B1 and 101B2 arranged on both sides of the inner cell stack group 101A may include the same number of cell stacks 101, but different numbers of cell stacks 101 may be included in consideration of the balance of the temperature distribution.

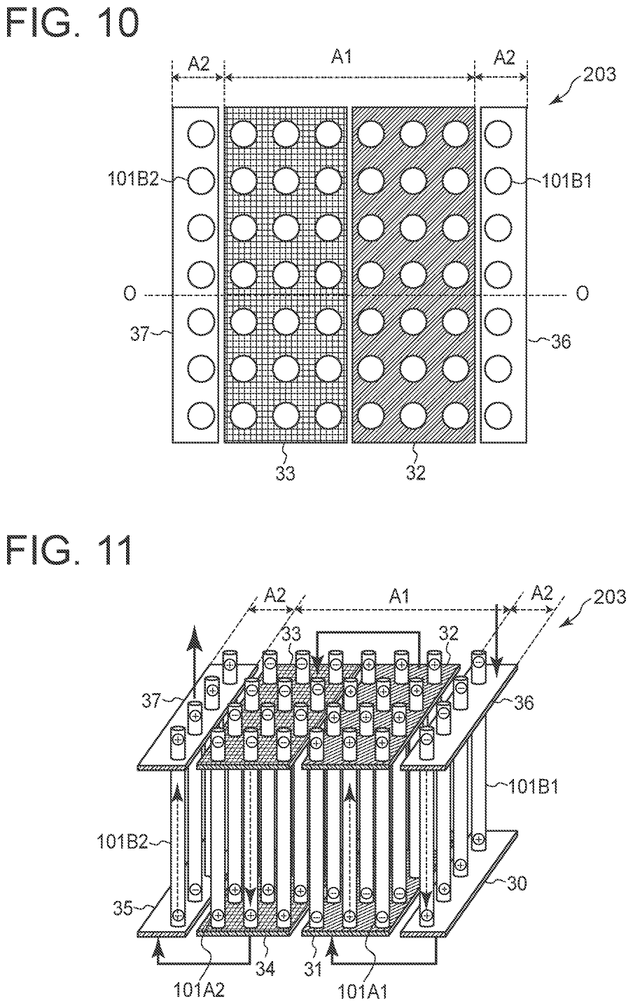

FIG. 10 is a second modification of FIG. 4, and FIG. 11 is a cross-sectional perspective view taken along the line O-O of the fuel cell cartridge 203 illustrated in FIG. 10. In the second modification, the inner cell stack group 101A is arranged between the outer cell stack groups 101B1 and 101B2, and the inner cell stack group 101A is further subdivided into a first inner cell stack group 101A1 and a second inner cell stack group 101A2.

As illustrated in FIG. 11, in a path in which current is circulated in the fuel cell cartridge 203, the current collector plate 30 (first positive electrode current collector) of the outer cell stack group 101B1 is electrically connected to the current collector plate 31 (first negative electrode current collector) of the first inner cell stack group 101A1. The current collector plate 32 (second positive electrode current collector) of the first inner cell stack group 101A1 is electrically connected to the current collector plate 33 (second negative electrode current collector) of the second inner cell stack group 101A2. The current collector plate 34 (third positive electrode current collector) of the second inner cell stack group 101A2 is electrically connected to the current collector plate 35 (third negative electrode current collector) of the outer cell stack group 101B2. The current collector plate 36 (fourth negative electrode current collector) of the outer cell stack group 101B1 and the current collector plate 37 (fourth positive electrode current collector) of the outer cell stack group 101B2 are connected to an external load. As a result, the path is formed by electrically separating the inner cell stack group (101A1, 101A2) and the outer cell stack group (101B1, 101B2) and electrically connecting the stack groups. This path is connected in series to an external load (not illustrated) in the path illustrated in FIG. 11.

As described above, in the second modification, the temperature distribution can be equalized by further subdividing the inner cell stack group 101A and changing the number of cell stacks included in each cell stack group to perform finer temperature adjustment as compared with the first modification. In this case, as in FIG. 9 of the first modification, the fuel cell cartridge 203 may be expanded by arranging a plurality of fuel cell cartridges 203 to be adjacent to each other.

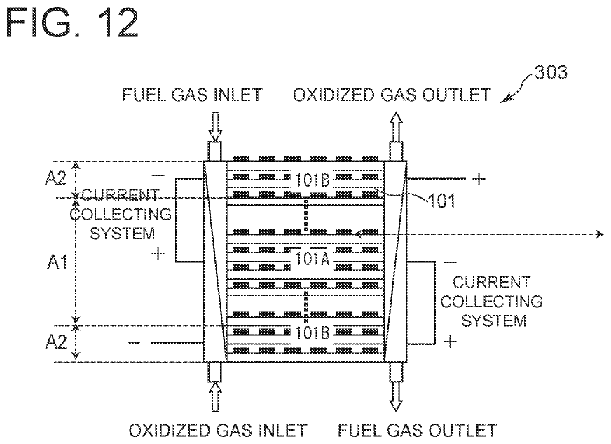

In the above-described embodiment, the case where the fuel cell cartridge 203 has the cylindrical cell stack 101 has been described, but the cell stack 101 included in the fuel cell cartridge 203 may have another type. FIG. 12 is a schematic view illustrating a fuel cell cartridge 303 having a flat cylindrical cell stack 101. The fuel cell cartridge 303 includes a plurality of cell stacks 101 extending in the horizontal direction and arranged along the vertical direction, and has a temperature distribution in which the temperature of the cell stack 101 on the upper side and the lower side (the outer side) where it makes contact with the outside air is lower than that on the inner side.

In such a fuel cell cartridge 303, the inner region A1 and the outer region A2 are defined, and a plurality of cell stacks 101 is classified into an inner cell stack group 101A located in the inner region A1 and an outer cell stack group 101B located in the outer region A2. The inner cell stack group 101A and the outer cell stack group 101B are connected in series to an external load (not illustrated) via a predetermined current collecting system.

Here, the cell stacks 101 included in the fuel cell cartridge 303 have the same conductive area, and the outer cell stack group 101B includes a smaller number of the cell stacks 101 than the inner cell stack group 101A. Therefore, when the inner cell stack group 101A and the outer cell stack group 101B connected in series to the external load are energized, the current density of the outer cell stack group 101B having a small total conductive area is configured to be higher than the current density of the inner cell stack group 101A having a large total conductive area. By setting the current density of the outer cell stack group 101B to be higher than that of the inner cell stack group 101A in this way, the temperature distribution can be effectively equalized.

As described above, according to the above embodiment, since the current density of the outer cell stack is set to be higher than the current density of the inner cell stack, the temperature distribution can be equalized between the outer cell stack having a larger heat dissipation amount than the inner cell stack and the inner cell stack having a smaller heat dissipation amount than the outer cell stack.

The fuel cell module 201 may be applied to a combined cycle power generation system used in combination with a GTCC (gas turbine combined cycle power generation), an MGT (micro gas turbine), or a turbocharger. In such a combined cycle power generation system, exhaust fuel gas and exhaust oxidized gas discharged from the SOFC module are supplied to a combustor (not illustrated) of a gas turbine to generate high-temperature combustion gas, and this combustion gas is adiabatically expanded by the gas turbine to generate rotational power. The compressor is driven with the rotational power and compressed gas is supplied to an oxidized gas supply main pipe 21 of the fuel cell module 10 as oxidized gas. The oxidized gas is a gas containing approximately 15% to 30% of oxygen, and air is typically preferable. However, in addition to air, a mixed gas of combustion exhaust gas and air or a mixed gas of oxygen and air can be used.

### INDUSTRIAL APPLICABILITY

At least one embodiment of the present invention can be used for fuel cell cartridges, fuel cell modules, and combined cycle power generation systems of solid oxide fuel cells.

### REFERENCE SIGNS LIST

101 Cell stack
101A Inner cell stack group
101B Outer cell stack group
103 Substrate tube
105 Single fuel cell
107 Interconnector
109 Anode
111 Electrolyte
113 Cathode
115 Lead film
201 Fuel cell module
203 Fuel cell cartridge
205 Pressure vessel
207 Fuel gas supply pipe
209 Fuel gas exhaust pipe
215 Power generation room
217 Fuel gas supply room
219 Fuel gas discharge room
221 Oxidized gas supply room
223 Oxidized gas discharge room
225a Upper tube plate
225b Lower tube plate
227a Upper insulation
227b Lower insulation
229a Upper casing
229b Lower casing
231a Fuel gas supply hole
231b Fuel gas exhaust hole
233a Oxidized gas supply hole
233b Oxidized gas exhaust hole
235a Oxidized gas supply gap
235b Oxidized gas exhaust gap
303 Flat cylindrical fuel cell cartridge
A1 Inner region
A2 Outer region

1. A fuel cell cartridge including a plurality of cell stacks including a plurality of cells forming a solid oxide fuel cell, wherein
the cell stack group comprising the plurality of cell stacks includes:
an inner cell stack group arranged in an inner region of a cell arrangement region in which the plurality of cell stacks is arranged; and
an outer cell stack group arranged in an outer region located outside the inner region of the cell arrangement region,
the inner cell stack group and the outer cell stack group are connected in series with respect to an external load, and
a current density of the outer cell stack group is configured to be higher than a current density of the inner cell stack group.

2. The fuel cell cartridge according to claim 1, wherein
the plurality of cell stacks have the same conductive area, and
the outer cell stack group includes a smaller number of cell stacks than the inner cell stack group.

3. The fuel cell cartridge according to claim 1, wherein
the cell stacks constituting the inner cell stack group and the cell stacks constituting the outer cell stack group are electrically connected by mutually independent current collecting members.

4. The fuel cell cartridge according to claim 1, wherein
the outer cell stack group surrounds an entire circumference of the inner cell stack group.

5. The fuel cell cartridge according to claim 1, wherein the outer cell stack group is arranged on both sides of the inner cell stack group.

6. The fuel cell cartridge according to claim 1, wherein
the inner cell stack group includes a first inner cell stack group and a second inner cell stack group that adjacent to each other, and
the first inner cell stack group and the second inner cell stack group are connected in series.

7. The fuel cell cartridge according to claim 1, wherein the cell stack has a cylindrical horizontal stripe shape in which a plurality of fuel cell cells are electrically connected in series.

8. The fuel cell cartridge according to claim 1, wherein the cell stack has a flat cylindrical horizontal stripe shape.

9. A fuel cell module comprising the fuel cell cartridge according to claim 1.

10. A combined power generation system comprising the fuel cell module according to claim 9 and a gas turbine or turbocharger that generates rotational power using an exhaust fuel gas and an exhaust oxidized gas exhausted from the solid oxide fuel cell, wherein
the fuel cell module is supplied with the oxidized gas compressed using the rotational power, and
the plurality of cell stacks generates power using the fuel gas and the oxidized gas.
